(19) United States
(12) Patent Application Publication
(10) Pub. No.: US 2004/0168111 A1
(43) Pub. Date: Aug. 26, 2004

(54) Graphic user interface for test equipment

(76) Inventors: Ross J. Arnold, Allentown, PA (US); Asha Chandra, Bridgewater, NJ (US); Mirek Fatyga, Macungie, PA (US); Priyesh G. Patel, Emmaus, PA (US); Joseph T. Poston, Charlotte, NC (US); Raymund C. Rimando, Whitehall, PA (US); Jonathan M. Streets, Emmaus, PA (US); William J. Thompson, Kempton, PA (US)

Correspondence Address: VOLENTINE FRANCOS, P.L.L.C., Suite 150, 12200 Sunrise Valley Drive, Reston, VA, 20191, US

(21) Appl. No.: 10/659,909

(22) Filed: Sep. 11, 2003

Related U.S. Application Data
(60) Provisional application No. 60/409,892, filed on Sep. 11, 2002.

(51) Int. Cl. H02H 3/05

(52) U.S. Cl. 714/57

(57) ABSTRACT

A graphical user interface for and method of interfacing with a controller of test equipment to effect desired controller settings including, but not limited to protocol traffic and signal quality. The graphical user interface being operable to facilitate the setting of a variety of test parameters relating to traffic, as well as a variety of test parameters relating to optics.

### CROSS-REFERENCE TO RELATED APPLICATIONS

The present application is related to and claims priority under 35 U.S.C. § 119(e) from U.S. Provisional Application Serial No. 60/409,892 filed on Sep. 11, 2002. The disclosure of this provisional application is specifically incorporated by reference.

### BACKGROUND

Equipment for testing the transmission and reception of information has increased in complexity along with the methods and apparati used for the transmission and reception. For example, certain known test equipment has a plethora of required settings that are not easily adjusted for a desired test, in spite of the high level of skill of the ordinary test engineer. Nonetheless, there remains a need to test and monitor a communications system, subsystem or device, or combination thereof during manufacture, deployment and post deployment.

A versatile, user-friendly interface is needed that facilitates the interaction of a user with the test equipment.

### SUMMARY

In accordance with an exemplary embodiment of the present invention, a GUI for interfacing with a controller of test equipment includes a display comprising a plurality of fields operable to set at least one protocol traffic parameter and signal quality parameter.

In accordance with another exemplary embodiment of the present invention, a method of interfacing with test equipment includes providing a display comprising a plurality of fields operable upon selection by a user to set at least one protocol traffic parameter and signal quality parameter.

In accordance with another exemplary embodiment of the present invention, a GUI for use in controlling test equipment comprises a test icon, an IntelliScript icon, a manual icon, a calibration icon and a monitor icon.

In accordance with another exemplary embodiment of the present invention, a GUI for use in controlling test equipment comprises a traffic icon for facilitating the setting of traffic related test parameters and an optics icon for facilitating the setting of optics related test parameters.

As such, it is an object of an embodiment of the present invention to provide a GUI for setting at least one protocol traffic parameter and signal quality parameter.

It is another object of an embodiment of the present invention to provide a method for interfacing with test equipment through a GUI operable to set at least one protocol traffic parameter and at least one signal quality parameter.

It is another object of an embodiment of the present invention to provide a versatile, use-friendly GUI for use in controlling test equipment

It is yet another object of an embodiment of the present invention to provide a GUI for setting test parameters relating to both traffic and optics.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion. To assist one in understanding the disclosure, like features in the accompanying drawings may be numbered alike.

FIG. 1 is a representation of a display of a GUI showing SONET bitstream definition options in accordance with an exemplary embodiment.

FIG. 2 is a representation of a display of a GUI showing SONET setup fields in accordance with an exemplary embodiment of the present invention.

FIG. 3 is a representation of a display of a GUI showing SONET setup fields in accordance with another exemplary embodiment.

FIG. 4 is a representation of a display of a GUI showing the setup field for a particular overhead byte value of a SONET overhead in accordance with an exemplary embodiment.

FIG. 5 is a representation of a display of a GUI showing byte selection fields in accordance with an exemplary embodiment.

FIG. 6 is a representation of a display of a GUI showing byte selection fields in accordance with an exemplary embodiment.

FIG. 7 is a representation of a display of a GUI showing the optics options in accordance with an exemplary embodiment.

FIG. 8 is a representation of a display of a GUI showing fields of a Bitstream Definition in accordance with an exemplary embodiment.

FIG. 9 is a representation of a display of a GUI showing bitstream options in accordance with an exemplary embodiment.

FIG. 10 is a representation of a display of a GUI showing various fields during a Bitstream testing sequence in accordance with an exemplary embodiment.

FIG. 11 is a representation of a display of a GUI showing sensitivity setup fields used in a Bitstream testing sequence in accordance with an exemplary embodiment.

FIG. 12 is a representation of a display of a GUI showing sensitivity results from a Bitstream testing sequence in accordance with an exemplary embodiment.

FIG. 13 is a representation of a display of a GUI showing S/X Measurement Results from a SONET testing sequence in accordance with an exemplary embodiment.

FIG. 14 is a representation of a display of a GUI showing fields under an IntelliScript icon in accordance with an exemplary embodiment.

FIG. 15 is a representation of a display of a GUI showing an S/X Penalty field under an IntelliScript icon in accordance with an exemplary embodiment.

FIG. 16 is a representation of a display of a GUI showing various fields for commencing and halting tests under an IntelliScript icon in accordance with an exemplary embodiment.

FIG. 17 is a representation of a display of a GUI showing a field for performing a plurality of tests in accordance with an exemplary embodiment.

FIG. 18 is a representation of a GUI showing sensitivity results in accordance with an exemplary embodiment.

FIG. 19 is a representation of a GUI showing test result details in accordance with an exemplary embodiment.

FIG. 20 is a representation of a GUI main page in accordance with an exemplary embodiment.

FIG. 21 is a representation of a traffic screen setup of a GUI in accordance with an exemplary embodiment.

FIG. 22 is a representation of an optical degradation screen setup of a GUI in accordance with an exemplary embodiment.

FIG. 23 is a representation of a switch configuration screen of a GUI in accordance with an exemplary embodiment.

FIG. 24 is a representation of a clock setting configuration screen of a GUI in accordance with an exemplary embodiment.

FIG. 25 is a representation of a main IntelliScript configuration in accordance with an exemplary embodiment.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. For example, various icons may vary in name and presentation from those set forth in the exemplary embodiments herein. Moreover, descriptions of well-known devices, methods and materials may be omitted so as to not obscure the description of the present invention.

Briefly the present invention as described in connection with exemplary embodiments herein, relates to a graphic user interface for applying a plurality of settings to a controller of test equipment. The test equipment is illustratively optical test equipment. Examples of such test equipment include the ‘Optical Standards Tester’ Models A3303, which operates at 2.5 Gb/s, and A3306, which operates at 10 Gb/s, and which are manufactured by Circadiant Systems, Inc. The controller with which the GUI may interface may be the ‘Optical StandardsTest Controller’ Model A3301 manufactured by Circadiant Systems, Inc. as well.

It is noted that throughout the description of the exemplary embodiments, applications software may assign a function for each particular icon, so that when an icon is selected, e.g., touched if a touch screen is used, the controller affects the requisite command (e.g., to the test equipment). Moreover, it is noted that a bus or point-to-point links may be used to effect the communication of commands to and from the various elements of the GUI, the controller and the test equipment.

Advantageously, the GUI provides a versatile, user-friendly interface to effect desired controller settings for test equipment that include, but are not limited to protocol traffic and signal quality in a manufacturing setting or in a field setting. The former setting facilitates quality control over products, while the latter facilitates field monitoring and fault analysis. Moreover, a large variety of different test patterns, protocols, and optical test conditions supported in optical communication systems may be affected in a user friendly manner via the GUI of the present invention. Once traffic patterns are generated by the test equipment by interfacing with the GUI, the user may monitor several different optical parameters and perform tests to qualify the transmission and reception of the traffic patterns. These and other features and advantages are described herein in connection with exemplary embodiments of the present invention.

As is well known, GUIs have been employed to facilitate interaction of a user with the file and execution system of a computer system, to present information graphically and/or in a manner approximating a printed page (“what you see is what you get” or “WYSIWYG”). Of course, there are other aspects of GUIs not encompassed by this generalization, but which are known to those skilled in the art. Typical graphic objects in a GUI are ‘icons’ presented on a display. These icons may be selected, which instructs the underlying operating system to take a desired action such as executing or opening a file, depending on its type, or to operate on one referenced file or application by another referenced application.

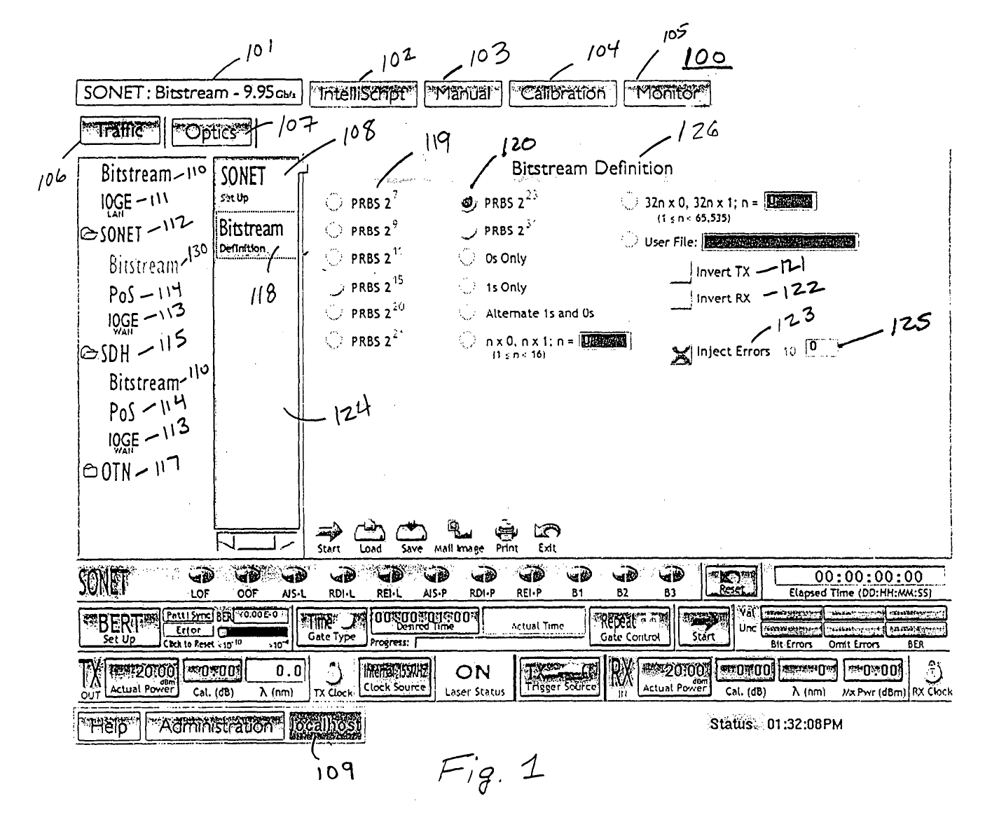

FIG. 1 shows a display 100 of a GUI in accordance with an exemplary embodiment of the present invention. The display may be disposed on a controller for test equipment or a piece of testing equipment (not shown) that includes a controller and with which the GUI interfaces. The display may be a touch screen device, whereby an icon is ‘touched’ by a stylus or by a digit to affect a desired operation by the controller. Alternatively, another operating system (such as a mouse-based system) may be used to effect the command execution of icons.

The display 100 illustratively includes a test icon 101; an Intelliscript icon 102; a Manual icon 103, for overriding settings that are usually set by the software of the test equipment/controller so as to enable manual selection of such settings; a calibration icon 104; a monitor icon 105; a traffic icon 106; and an optics icons 107. A detailed explanation of the function of these icons will be explained in logical order of use herein.

One advantageous aspect of a GUI in accordance with an exemplary embodiment is the capability to interface with a controller that can control a number of test devices (e.g., the test equipment referenced above) via a network (e.g. a LAN). To this end, by selecting a local host icon 109, a menu of test equipment known to be on the local network is provided. Via this menu on the GUI, a particular unit may be selected for control by the controller may be selected.

As referenced, one main icon of the display 100 is the selection of “Traffic,” while another main icon is “Optics”, which are displayed because test icon 101 has been selected. The traffic icon 106 and the optics icon 107 comprise the signal configuration editor that provides the interface between the user and the test equipment. This signal configuration editor allows the user to configure the characteristics of the optical signals output from the test equipment to the device under test. Selection of the traffic icon 106, as in FIG. 1, further provides a panel, which includes a number of possible protocol icons. These include, but are not limited to (Unframed) Bitstream 110, 10 Gigabit Ethernet (10GE) LAN 111, (SONET framed) Bitstream 130, 10 GE WAN 113 and Packet over SONET (PoS) 114. One can touch the “file folder” to toggle between opening and closing it. As shown, the file folders icons for SONET 112 and for SDH (Synchronous Digital Hierarchy) 116 are open, whereas an OTN (Optical Transport Network) 117 icon is closed. It is noted that in accordance with exemplary embodiments of the present invention, the GUI allows a user to open a folder to determine which options associated with some broad category of transport the user wishes to select.

For example, SONET can be used to transport a bitstream, to provide Packet over SONET (PoS), or 10GE Wide Area Network (WAN). Selection of any of these icons provides access to further options. In the illustrated display 100, a Bitstream icon 110 under the SONET icon 112 is selected.

With Bitstream icon 110 selected, the next panel 124 is then provided including icons, which represent categories to be set up or defined. The choice of categories is context sensitive. Only SONET Setup 108 and Bitstream Definition 118 are appropriate for the shown choice of Bitstream 130 under SONET 112. In this example, Bitstream Definition 118 is selected. A number of possible Pseudo Random Bit Sequences (PRBS) 119 options are opened in a Bitstream Definition window 126. In this exemplary embodiment, the chosen sequence is PRBS 2²³ 120, which would be more accurately described as 2²³−1 in repetition interval. Any of the other PRBS patterns 119 could have been chosen, but a number of patterns, such as PRBS 2⁷, may be listed as not available, which may be due to test equipment limitations, for example.

It is noted that the GUI provides number of “check box” icons, including an Invert TX icon 121 and Invert RX icon 122 that have not been selected in the present example but the Inject Errors icon 123 has been selected. An exponent icon 125 could be selected to choose a different exponent.

Numerous other icons are present in the in display 100 of FIG. 1. For ease of disclosure and to assist in understanding, many of these icons not discussed with respect to FIG. 1 that appear in other figures, are discussed below with respect to such figures.

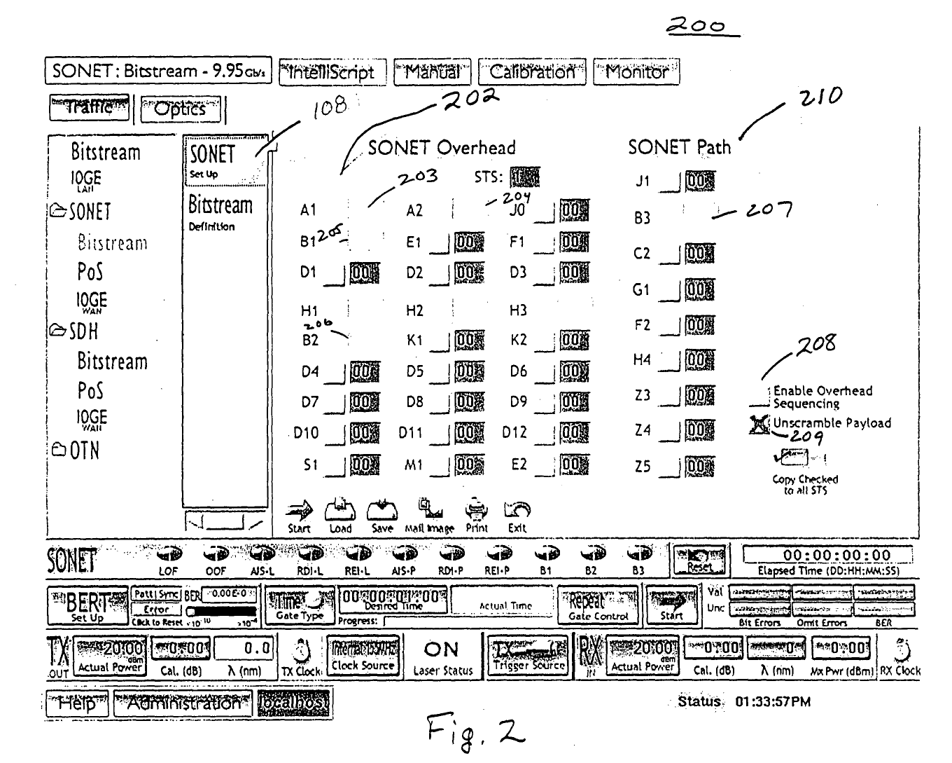

An exemplary display 200 is shown in FIG. 2, and is affected by selecting the SONET Set Up icon 108. With the SONET Set Up icon 108 selected, a setup window is opened, which is appropriate for specifying the values of the various SONET overhead bytes 202 or SONET path bytes 210. It should be noted that certain bytes, such as the A1 203 and A2 204, are generally not supposed to be specified in testing. These two bytes are used by the framer for synchronization. Other overhead bytes are used for parity checking: B1 205, B2 206, and B3 207, and therefore are also not generally intended to be specified. Many of the overhead bytes may be those intended by a standard, such as Telecordia GR-253-CORE, Issue 3, September 2000, for maintenance communication between different Network Elements (NE) (not shown). In the exemplary embodiment shown, the bytes that generally are not intended to be changed are shown as unavailable for changing. The listed values of other bytes may be changed via the GUI by selecting the appropriate icon(s) (which may cycle through various predefined choices or bring up a ‘pop-up’ window to permit specification of the changes), or, if a keyboard is available, changes may be made by ‘tabbing’ between the numerical fields and enter the numbers directly from the keyboard. It is noted that in this example, the Enable Overhead Sequencing icon 208 is not selected, whereas the one below it, the Unscramble Payload icon 209 is selected.

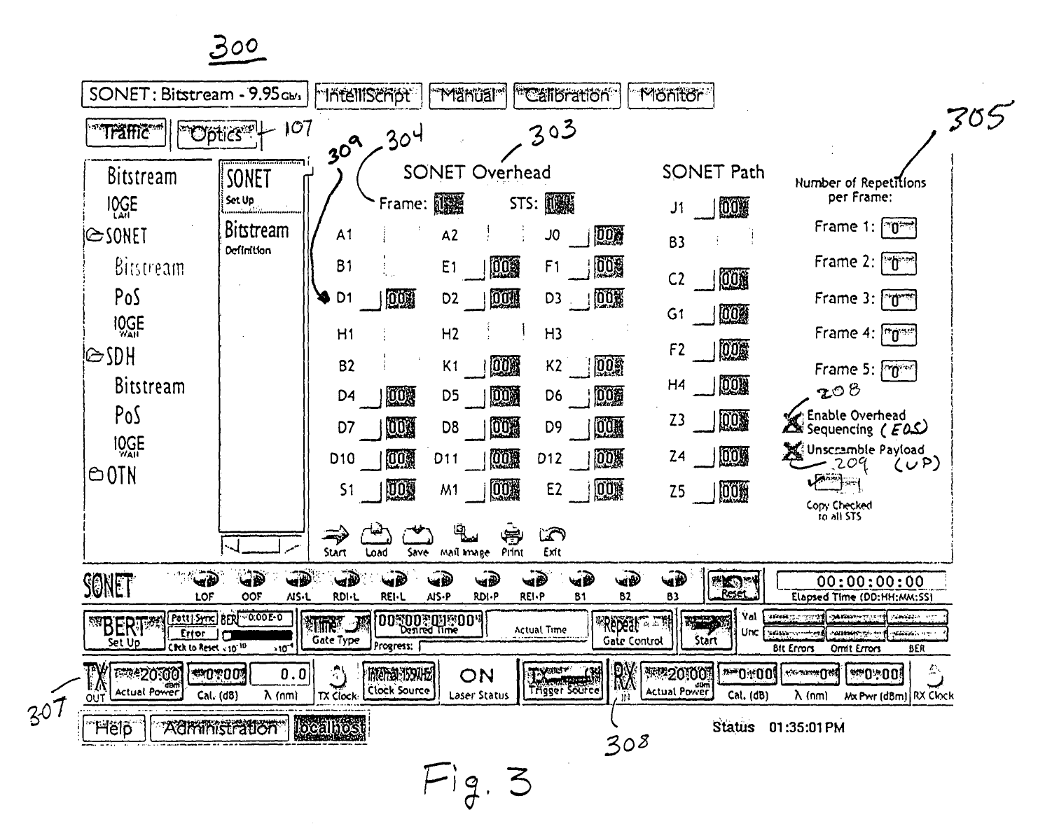

FIG. 3 shows a display 300 in which the Enable Overhead Sequencing icon 208 and the Unscramble Payload 209 icon have both been selected. With the addition of the selection of the Enable Overhead Sequencing icon 208 certain other fields are presented. In the SONET Overhead field 303, a Frame icon 304 appears with a “1” in it. Also, a new group of icons have appeared on the right side under the Number of Repetitions per Frame field 305, which includes five frame selection icons as shown.

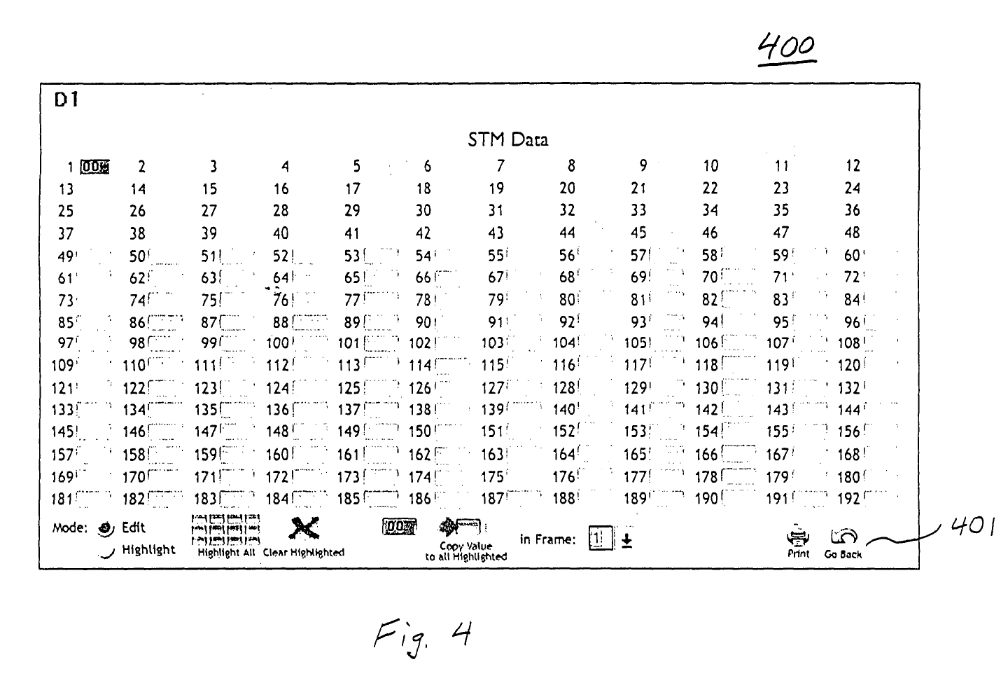

When the Dl overhead byte value 309 is selected, most of the display is overlayed with a pop-up selection window 400 shown in FIG. 4. The values can be edited by selecting a given byte icon. By selecting a Go Back icon 401 that is in the lower right, the pop-up selection window 400 disappears and the user is returned to the display from which they came, e.g., 300 of FIG. 3.

The test equipment (not shown) usefully produces an optical signal of controllable characteristics. To adjust the power related settings, the user selects the appropriate places of the TX icon 307 and RX icon 308. Also, the choice of units for optical power can be either “dBm” or “mW”. More subtle optical control is by selecting the Optics icon 107.

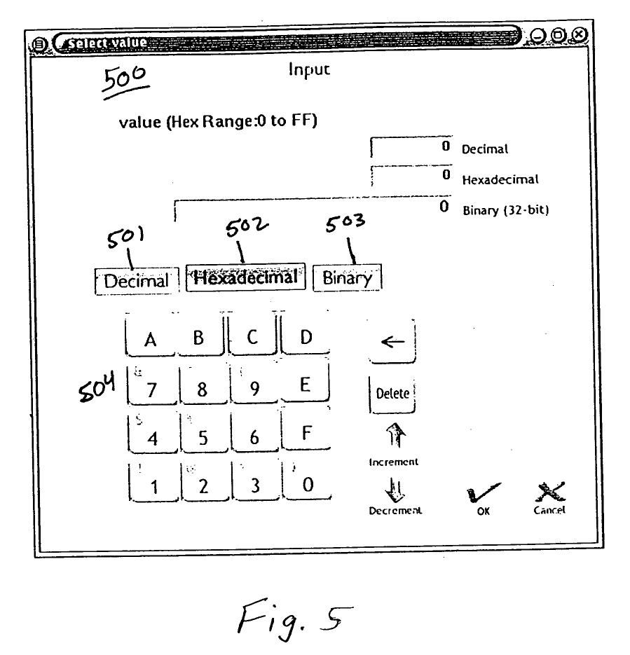

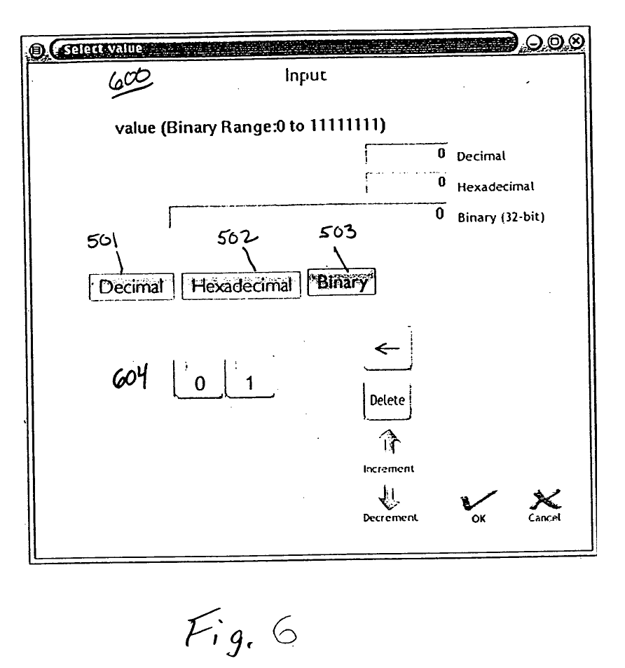

FIGS. 5 and 6 illustrate the flexibility in the choice of representation that the GUI of the present exemplary embodiment offers. When one is changing the value of a byte such as a byte shown in FIG. 4, one can enter the value in decimal, hexadecimal, or binary. A pop-up window 500 or 600 of FIG. 5 or 6 respectively, can be displayed upon selection of a byte to change. Pop-up windows 500 and 600 each have three icons, decimal 501, hexadecimal 502, and binary 503, for selecting the numbering system to be used. Limits (typically 0 to 255 in decimal, 00 to FF in Hexadecimal, 00000000 to 11111111 in binary) are displayed for the number system chosen and a keypad (504 or 604, e.g.) composed of numbered icons is presented, preferably with only 2, 10, or 16 numeric keys, depending upon the numbering system icon 501, 502 or 503 selected.

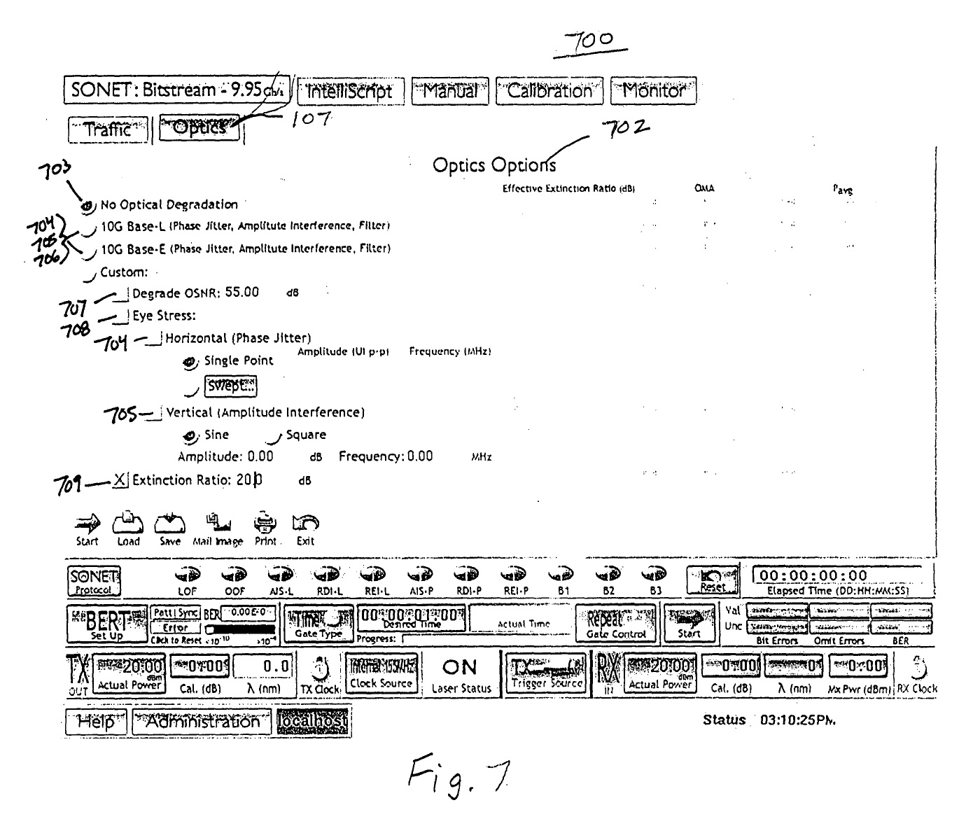

FIG. 7 shows a display 700 of a GUI in accordance with an exemplary embodiment of the present invention. In this example, the Optics icon 107 has been selected, opening up an Optics options field 702. The Optics options field 702 includes icons that enable the user to select the quality of the optical signal to be sent through the optical link by the test equipment, and tested thereby. These include, but are not limited to icons for no optical degradation 703, phase jitter 704, amplitude interference 705 and signal filtering 706. The signal degradation may be customized by the user, with selections including OSNR level 707, Eye Stress 708, Extinction Ratio selection 709, and others.

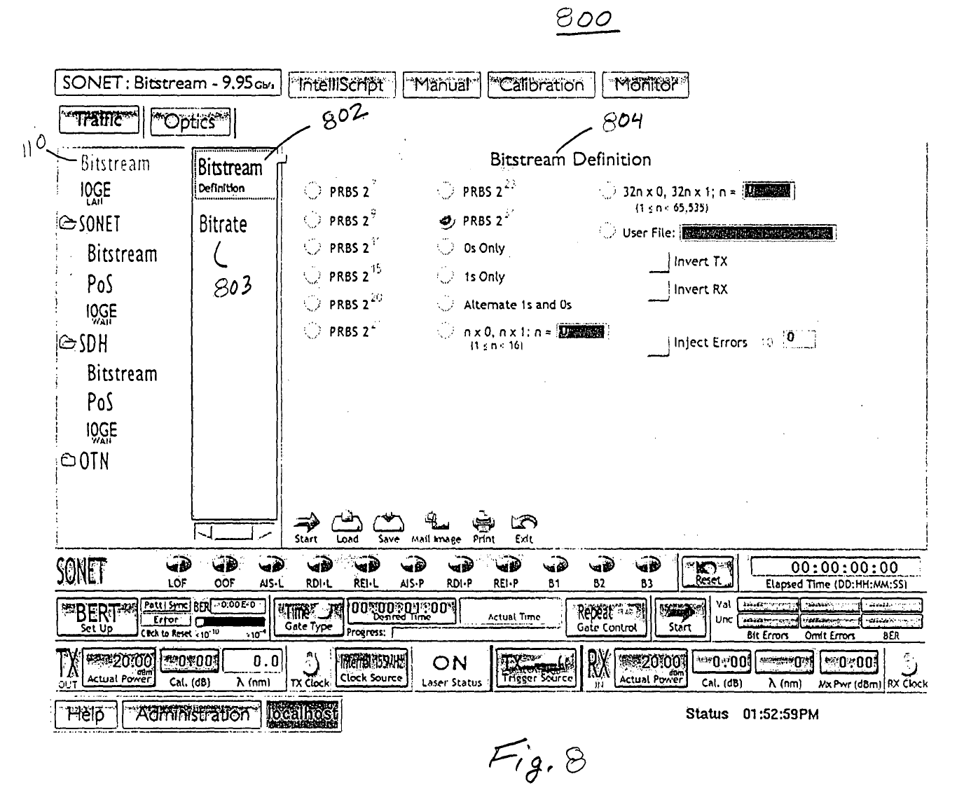

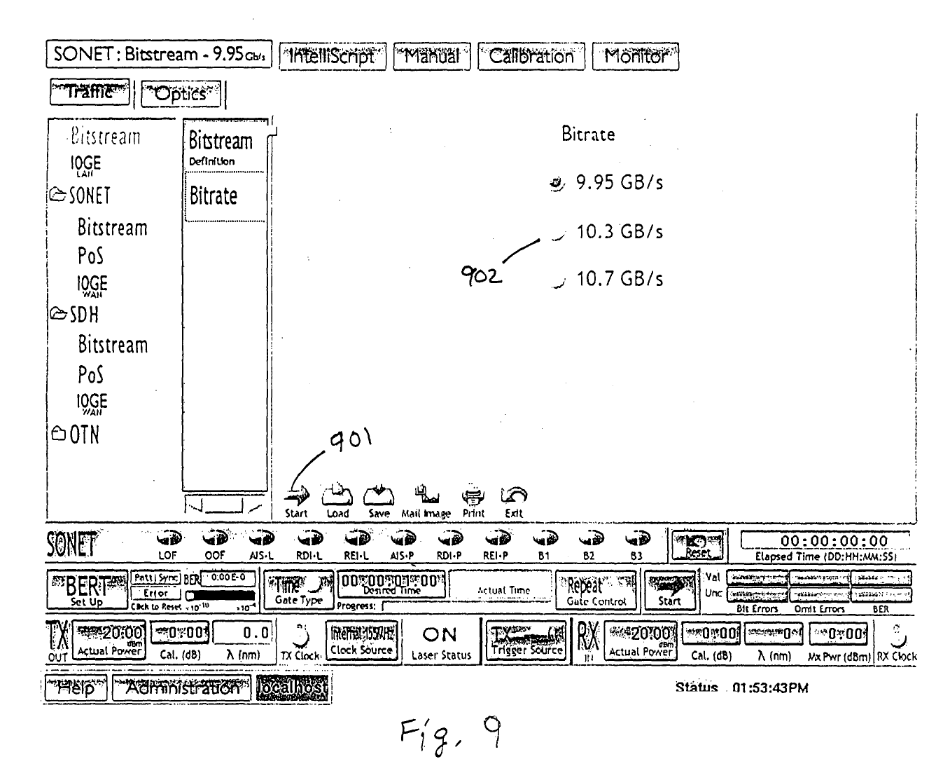

FIGS. 8 and 9 illustrate displays in which the raw or unframed “Bitstream” icon 110 has been selected. It is noted that with Bitstream icon 110 selected, the parameters can be set via a selection of a Bitstream Definitions icon 802 or a Bitrate icon 803. Note that in FIG. 1, a Bitstream icon 130 is selected within the SONET framework icon 112. Thus, via context sensitive panel icons, the user is not prompted to make SONET setup selections in FIGS. 8 and 9 as they had been in the case of the display of FIG. 1. Instead, the user will need to specify the bitrate via Bitrate icon 803(which is not adjustable and thus not present under the SONET case).

With Bitstream Definition icon 802 selected, the Bitstream Definition field 804 is opened. It is noted that this field is not the same as it was in FIG. 1. Although they are similar, there may be different hardware capabilities involved and, hence, the choice for “PRBS 2¹⁵” that was available in FIG. 1 may not be available in FIG. 8.

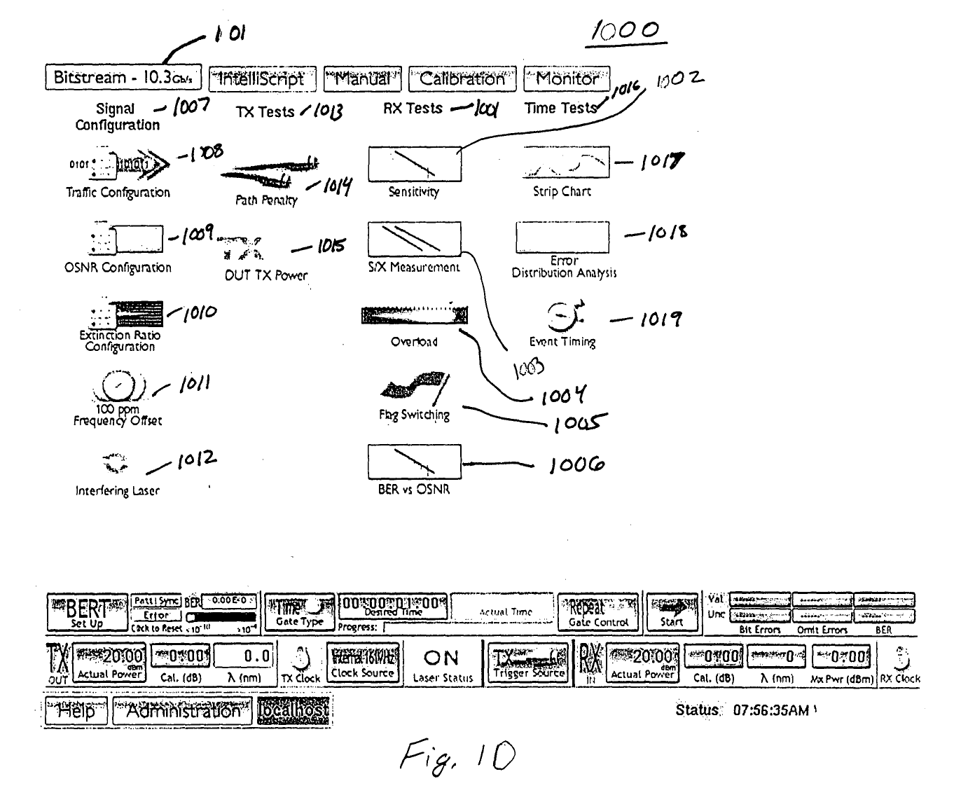

As mentioned previously, without having a SONET based bit stream, the user can choose a different “Bitrate” via selection of Bitrate icon 803. This is shown in FIG. 9. By selecting the 10.3 GB/s icon 902, for example, the user can choose that bit rate instead of the one shown. Once the user has decided that parameter (“BitStream” and “Bitrate”) setup is complete, he/she can press the Start arrow icon 901 that is part of the horizontal set of 6 common icons present on most displays of the GUI, which provides access to the embodiment of FIG. 10, e.g.

FIG. 10 shows a display 1000 in accordance with another exemplary embodiment of the present invention via selection of the Start icon 901 from the embodiment of FIG. 9 after selection of 10.3 GB/s icon 902. Test icon 101 now denotes “Bitstream—10.3 Gb/s”. This icon is on and indicates that the test equipment is now transmitting this pattern. If it were off it would indicate that the signal was disabled. Also, because SONET framing is not selected, the SONET bar, that was present previous Figs. near the bottom of the display is now absent. The user may make further choices. For example, by selecting the Sensitivity icon 1002 under RX tests field 1001, the user can determine and select the parameters related to sensitivity testing that are desired. The user makes the selection via the GUI, and the GUI communicates these parameters to the controller of the test equipment. Other icons in RX tests field 1001 include: S/X Measurement 1003; Overload 1004; Flag Switching 1005; and BER vs. OSNR 1006. In Signal Configuration field 1007 the following icons are presented: Traffic Configuration 1008; OSNR Configuration 1009; Extinction Ratio 1010; Frequency Offset 1011; and Interfering Laser 1012. In TX Tests field 1013, Path Penalty 1014 and DUT TX Power 1015 are available. And under the Time Tests field 1016, the following icons are presented: Strip Chart 1017; Error Distribution Analysis 1018; and Event Timing 1019. Each of these icons facilitates a user's setting of parameters corresponding with that icon's name.

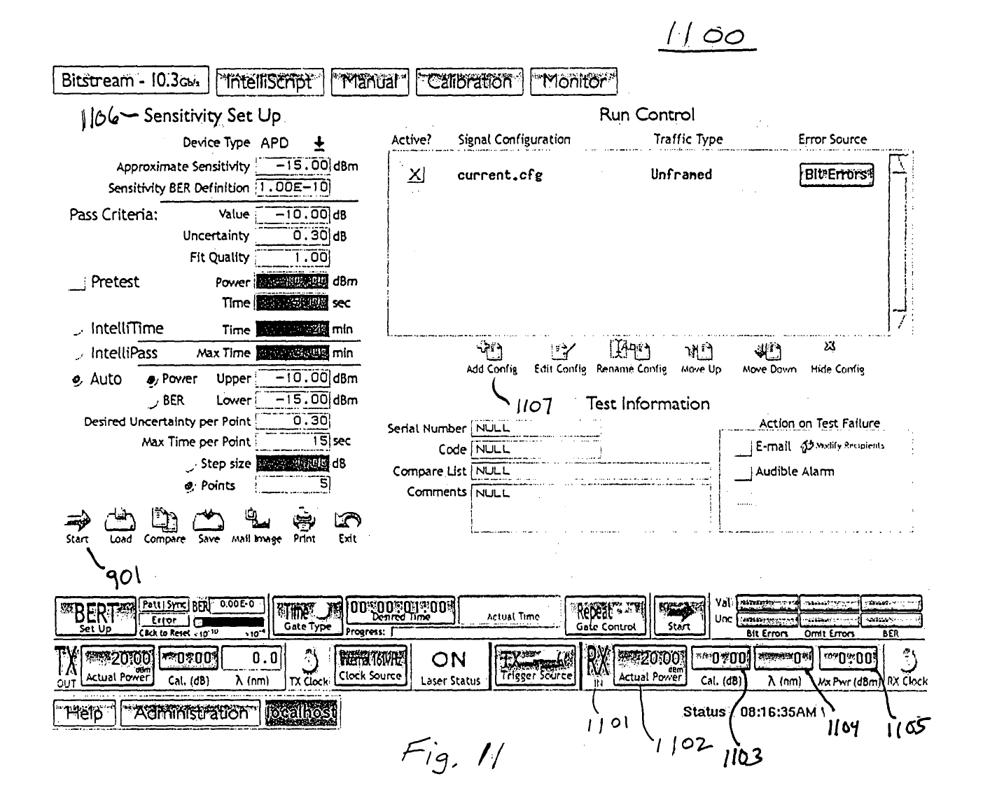

For example, the selection of the Sensitivity test icon 1002 results in the display 1100 shown in FIG. 11. It is noted that for a given type of signal the Bit Error Rate (BER) depends upon the strength of the signal. If the received optical signal power is too weak, many bit errors will result. The error rate declines sharply with relatively small increases of signal power. The “sensitivity” of a receiver is the minimum average optical power needed in order that the BER is, say 10⁻¹². The range of optical power that can be delivered to the receiver is quite large. If the power is too great, one can damage the receiver. So it saves time and reduces the chance of damage if one knows at what approximate power one should test. An additional concern is that if one is trying to measure the BER at very low error rates, one needs to wait a long time on the average to see even a few errors occurring.

In order to protect the receiver, the user can specify the maximum power level that may be presented to the receiver. At the lower right is the RX in icon 1101. Following the RX in icon 1101 is an indication of the actual power (shown here as −20 dBm) in actual power icon 1102, which could be changed to read in units of mW if one prefers by selecting that icon. Also shown are a calibration factor icon 1103, a wavelength icon 1104, and a maximum power icon 1105. By selecting the maximum power icon 1105, one is prompted to supply a new value. Whatever value that is chosen will be used to protect the receiver.

00064 For example, suppose the transmission rate is 10 Gb/s. If the BER happens to be 10⁻⁹, then there would be about 10 bit errors each second or about 600 bit errors after a minute of operation. There will be statistical fluctuations and so one minute might see 575 errors and another minute will see 623 errors, etc., so it is not expected that one would get the exact BER for a short experimental duration, but as the length of time that the experiment is run, the more precise results one expects.

Now suppose that the BER is 10⁻¹². It is expected to that less than one error occurs every minute. On the average, about 36 bit errors would occur each hour. It may not be efficient to run the experiment long enough to get very precise estimates of the BER in this case.

It is customary to plot the BER versus received average optical power and extrapolate the trend to estimate the BER for low values that are too time consuming to measure directly. This can be done using non-linear plotting techniques to make the BER vs. power plot appear linear for most well understood conditions. It is often useful to extrapolate a linear trend. This extrapolation can save a tremendous amount of testing time to obtain needed sensitivity values for a Device Under Test (DUT). After the details of the sensitivity measurement are chosen, the user may press the Start arrow icon 901 that is situated on the left below the Sensitivity Set Up panel 1106.

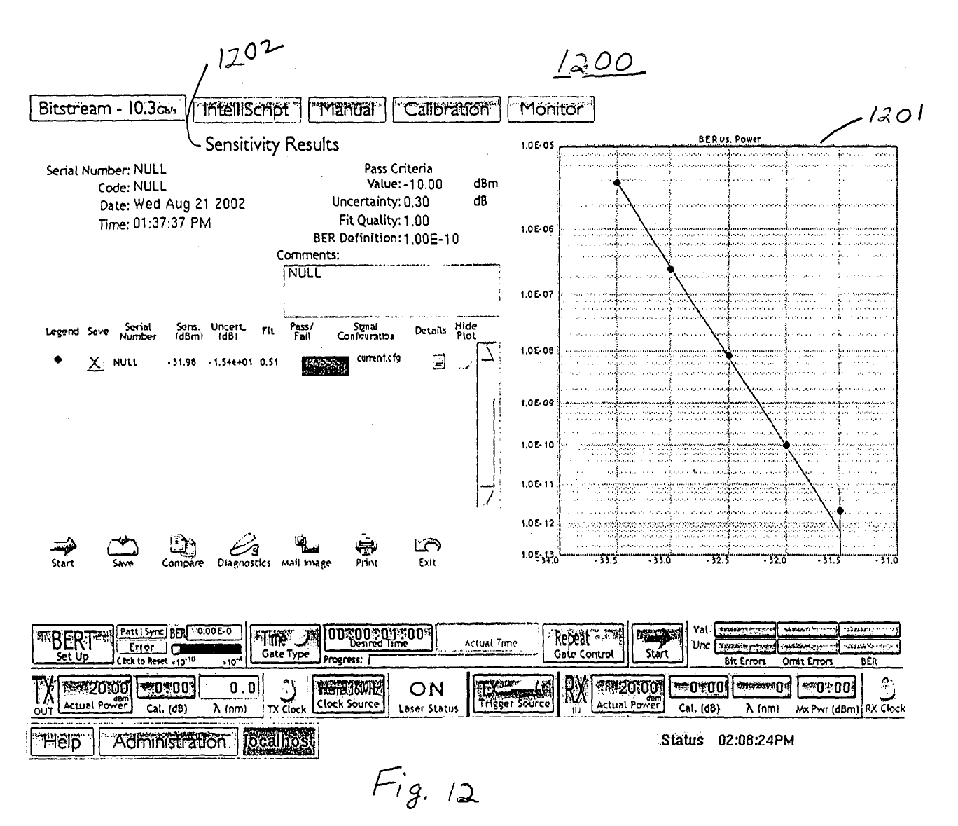

This results in the exemplary Sensitivity Results display 1200 of FIG. 12. The test equipment is now testing the DUT and as each point (BER vs. power) is determined, it is recorded on the “BER vs. Power” plot 1201 on the right side of the exemplary display 1200. The plot is designed so that with power recorded in dBm and the BER recorded in a very non-linear manner, the resulting curve is usually well described by a straight line as seen. It is noted that for low BER points there is usually a noticeable uncertainty in the measured BER, indicated on the plot by a vertical line segment whose vertical range suggests reasonably possible alternatives to the one reported BER (a round spot). It is an important and unique feature that the plots will provide “error bars” because the BER determinations use software routines that determine the uncertainty as well as the expected BER and, also, that this information is entered into the plotting functions and is used to weight the fitting routines that plot the straight line fits. Thus the point recorded at the lower right did not influence the position of the straight line fit as much as the other 4 points.

It is further noted that the Sensitivity results field 1202 shown on the left highlight whether the DUT was a “PASS”, a “FAIL” or an “UNKNOWN”. The PASS is preferably highlighted in green, whereas the other cases are highlighted in a red background. The “UNKNOWN” applies to cases where the test could not complete or the criteria were not sufficiently different from the test result that with the test uncertainty, a definitive decision between the PASS and FAIL categories could not be made.

Other tests of the DUT receiver are possible. To wit, there are 5 RX Tests available through icons in FIG. 10. The user could choose to measure SIX (signal power-over-interfering laser power, measured in dB) through the selection of S/X Measurement icon 1003.

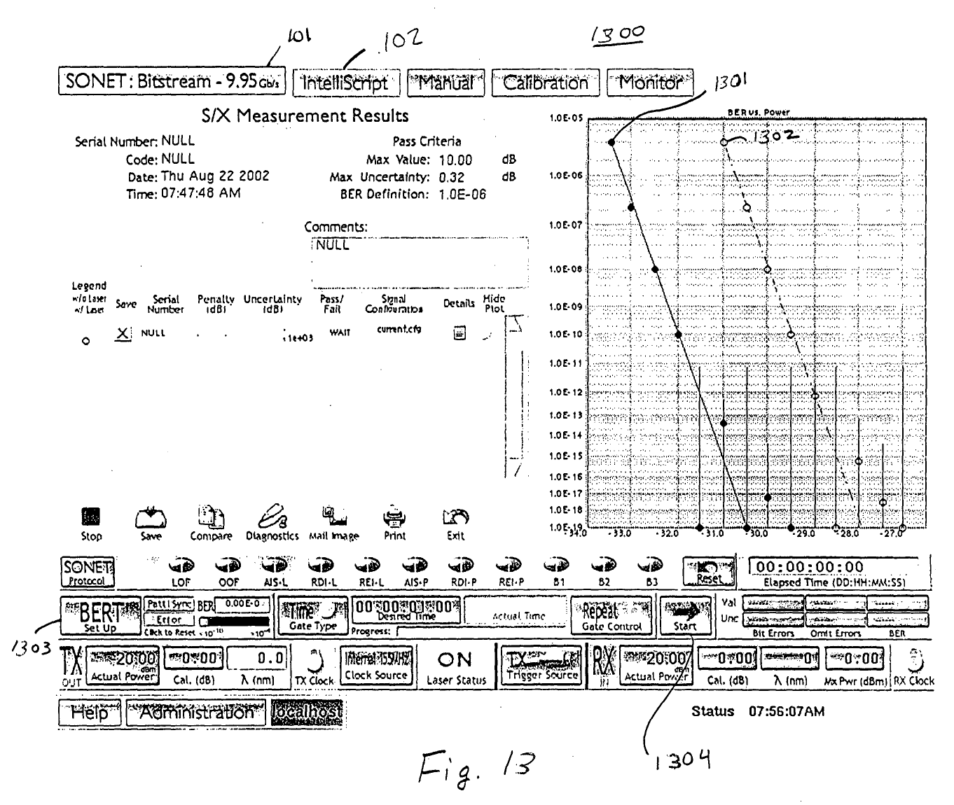

An example of the display presented to a user when an S/X Measurement test is selected is shown in exemplary display 1300 in FIG. 13. It is noted that in this example, a SONET bitstream of 9.95 GB/s is being transmitted as shown in test icon 101. In this exemplary embodiment, two sets of data are taken: solid points 1301 without an interfering laser (shown with their extrapolated linear plot which should yield generally the same results as for the sensitivity measurements) and hollow points 1302 (with their extrapolated linear plot) for when the interfering laser is present. Sometimes the customer wants to see “how open” the receiver eye is open. The effect of the (modulated) interfering laser is to raise the eye relative to the decision point when the interfering laser is momentarily in high power and then lower the eye below its normal position relative to the decision level when the interfering laser is momentarily in low power. Thus, increased BER are seen due to the threshold being too high and too low relative to the nominal place near the center of the receiver eye. As can be appreciated, a variety of tests may be readily affected by the user through the GUI to the controller of the test equipment.

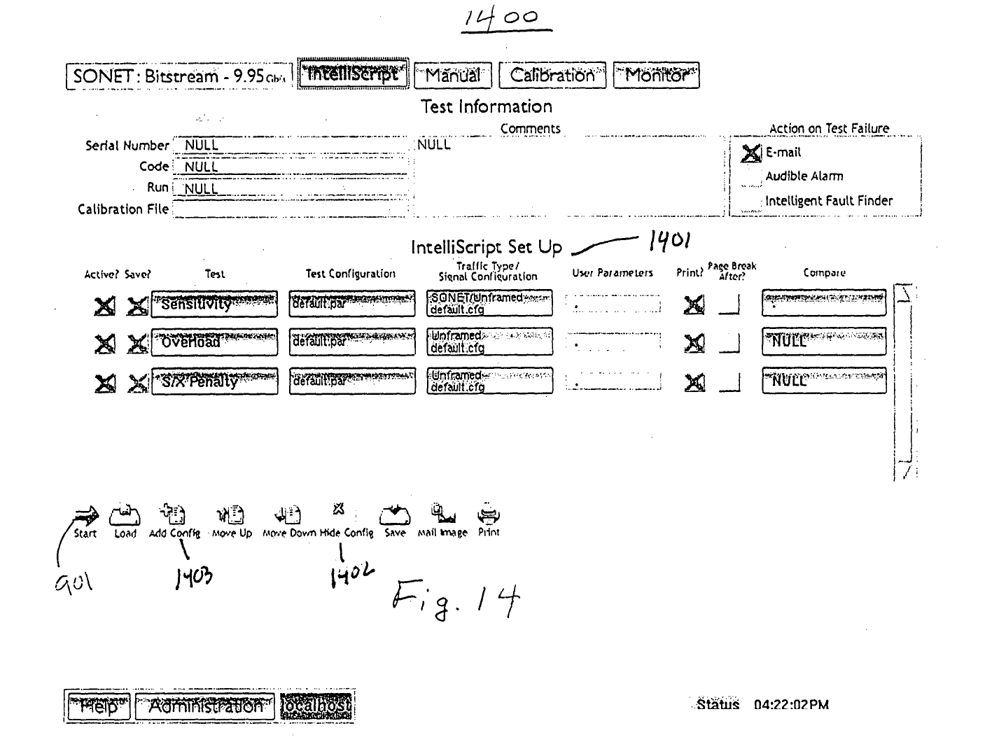

Moreover, there are different levels of automation possible, which is particularly useful in manufacturing testing and field monitoring. If the user wanted just to perform a BER test and not a sensitivity run, he/she could have selected the BERT icon 1303 at the bottom of the display 1300. After setting up the details for the BER test and double checking that the data and optical power are as desired, we would press the “Start button” 1304 right side of the BERT bar. At the other extreme of automation, the user may desire to perform a suite of tests such as sensitivity, overload, and S/X. To perform a suite of tests the user touch the IntelliScript icon 102 at the top of the display 1300 of the GUI. Once the IntelliScript icon is selected, display 1400 shown in FIG. 14 results.

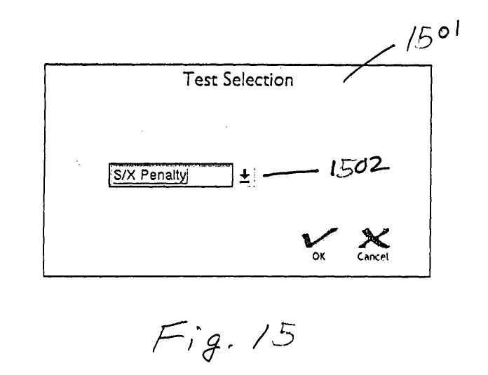

Now the user can select the device under test (DUT) information, comments, and “Action on Test Failure”. The IntelliScript Set Up field 1401 is the listing of the tests to be performed. One can shorten or increase this list length with the Hide Config 1402 and Add ConFig 1403 icons at the bottom. IntelliScript Set Up field 1401 offers a great deal of options. For example, to change the third test one can select the S/X Penalty icon and a test selection pop-up window 1501 appears on the display as shown in FIG. 15. Touching the down arrow icon 1502 produces a drop down menu with all the possible tests listed. Also, for each test listed in the IntelliScript, the user can check or uncheck options to save, print, and page eject (not shown).

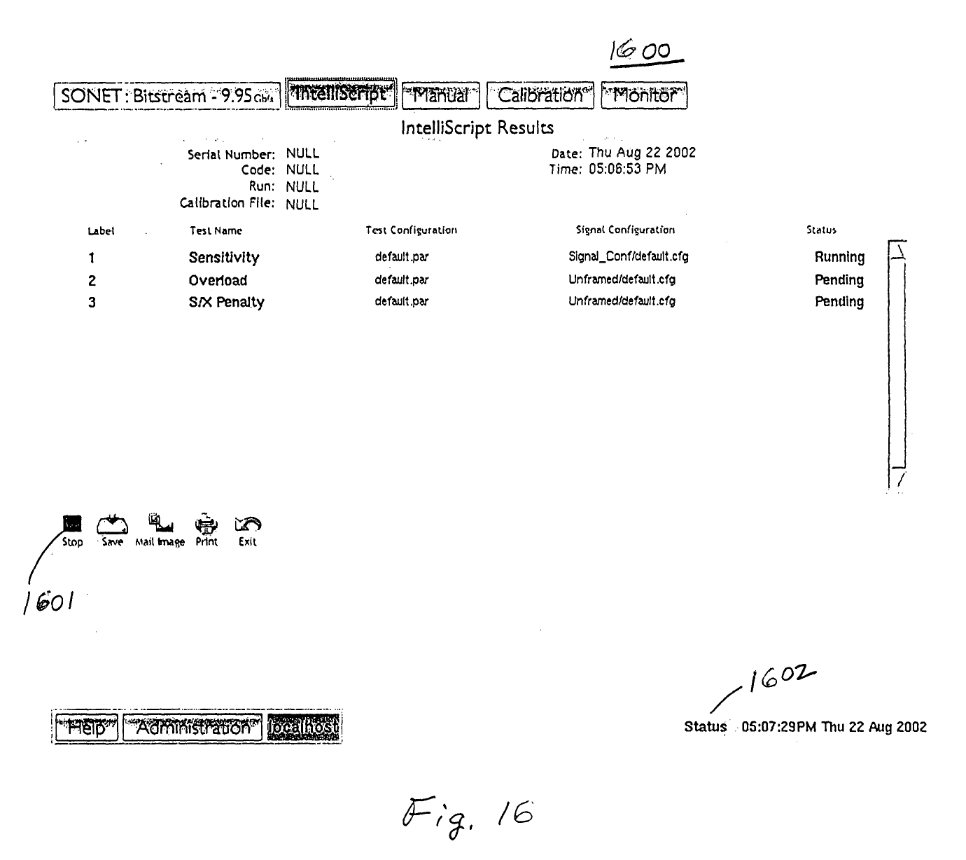

After the IntelliScript is set up, the user can command the controller to initiate testing by selecting the Start icon 901 of FIG. 14. When this is selected, the GUI display 1600 shown in FIG. 16 results. While tests are running, the Start icon 901 is replaced by a Stop icon 1601 so that one can cease the testing at any time. Also, to gauge the progress of status, the user can touch the green Status icon 1602 in the lower right. That will result in a text script reporting what is happening for each individual test step that has been completed.

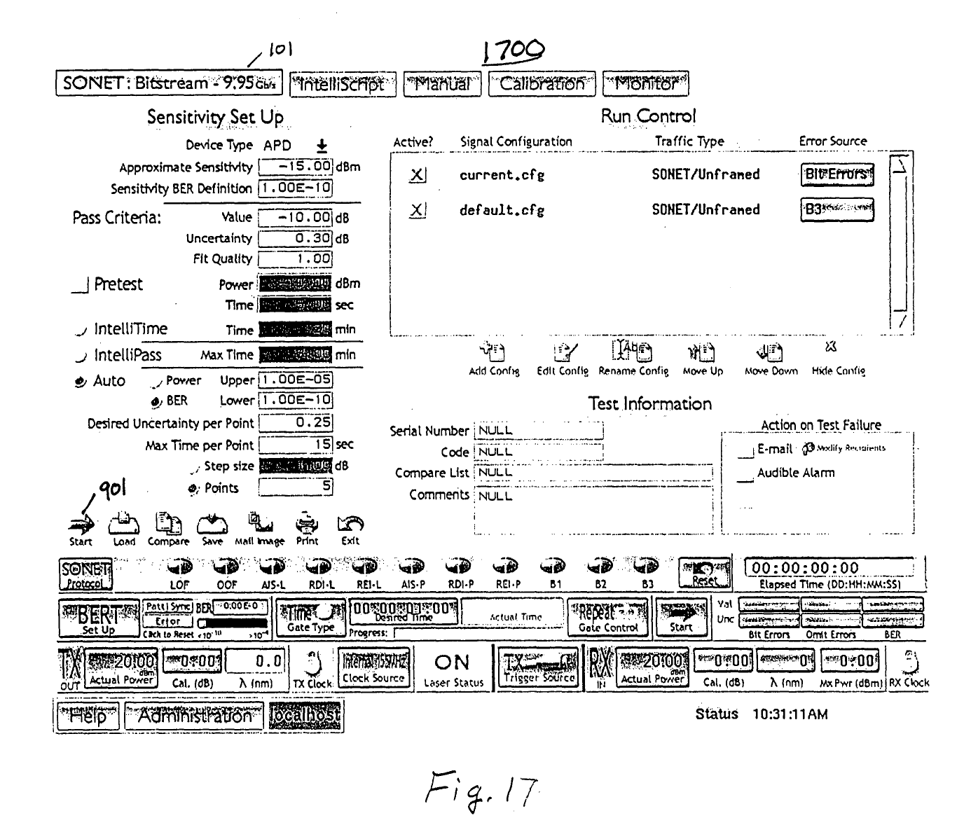

IntelliScript is not the only way one can perform a suite of tests. For example, in the GUI display 1100, it is possible to select Add Config icon 1107. Doing so prompts a user for a new configuration (in the display 1100, a default configuration was chosen) and the result is a GUI display like 1700 of the exemplary embodiment of FIG. 17. It is noted that test icon 101 in FIG. 17 shows a SONET bitstream at 9.95 GB/s rather than the “Bitstream 10.3 GB/s” shown in FIG. 11. The principles of adding or removing items from the list are analogous to the IntelliScript Set Up of FIG. 14. The difference here is that there are no printer options for each individual test.

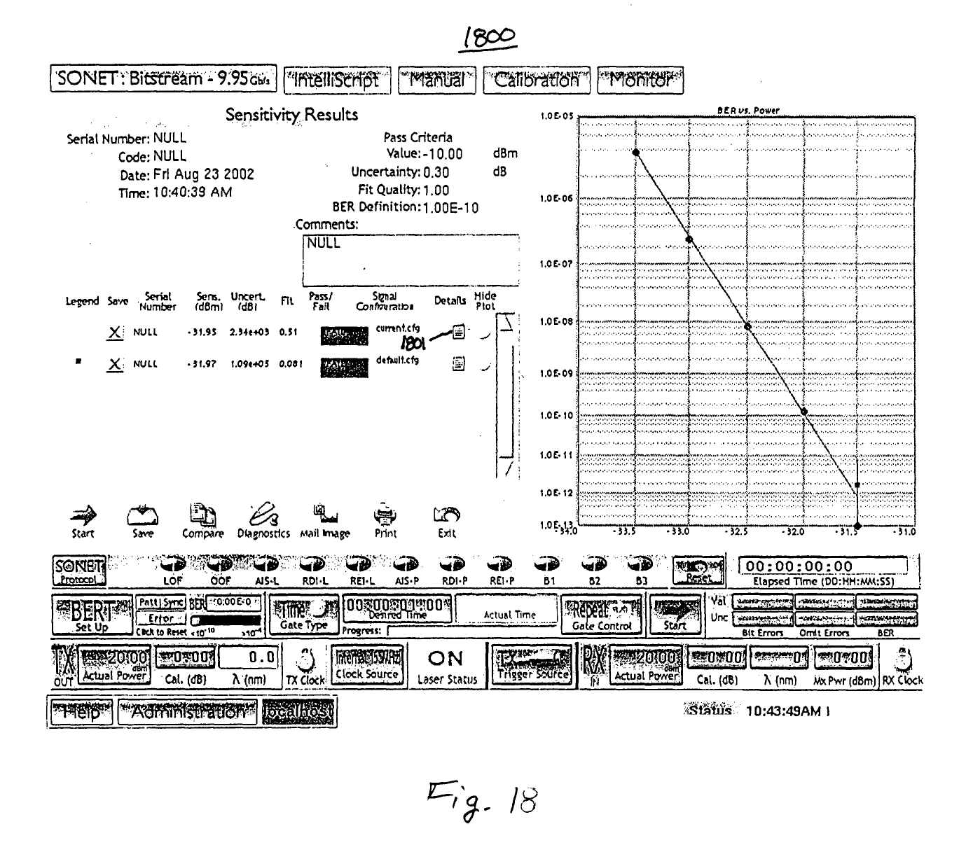

When the Start icon 901 from FIG. 17 is selected, each of the test plots for the tests utilizing the current.cfg and the default.cfg files is overlaid in the same plot, as shown in GUI display 1800 of FIG. 18. Because the run conditions are so similar, the runs are not discernable since they are largely overlaid. At the lowest BER. the number of errors seen is so few that the statistical fluctuations enable one to see very different plotted positions from run to run; that the two tests show clearly different points here. At higher BER, one may wish to select the “details” icon 1801 that looks like a notepad.

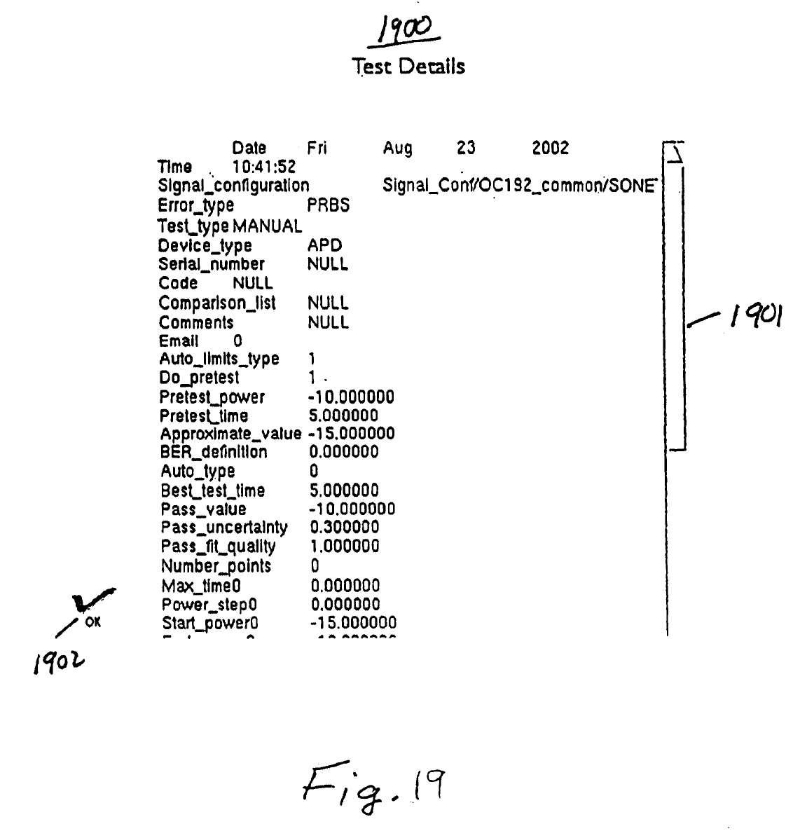

A typical Test Details display 1900 is shown in FIG. 19. To see the bottom of the listing, one would use the scroll bar icon 1901 on the right. To end the review and to see the underlying FIG. 19, one would touch the OK icon 1902 on the lower left.

As can be appreciated by one skilled in the art, the ease of comparison is also facilitated by the GUI of the exemplary embodiments of the present invention. For example, the existence of any difference resulting from the use of different test patterns, to varying the amount of optical eye stress and/or extinction ratio can be discerned. The user can compare different ways to monitor errors, for example in SONET one could use bit errors directly or one could use B1 or B2.

From the previous description of exemplary embodiments of the present invention, certain advantages can be appreciated. For example, the test equipment (via the GUI) controls light levels and signal impairments; data rates; data patterns and transmission protocols and packets. The GUI displays errors at the bit level, at the parity level (BIP-8 in SONET) and it observes errors at the packet level; and the test equipment tests over a range of mutually incompatible protocols. Supporting the physical layer characteristics (light level, jitter, vertical eye margin, contrast ratio), the encoding layer, and several transport layers (SONET, PoS, 10G Ethernet) is affected in a straight-forward manner via a GUI that is greatly simplified compared to other interfaces used in test equipment.

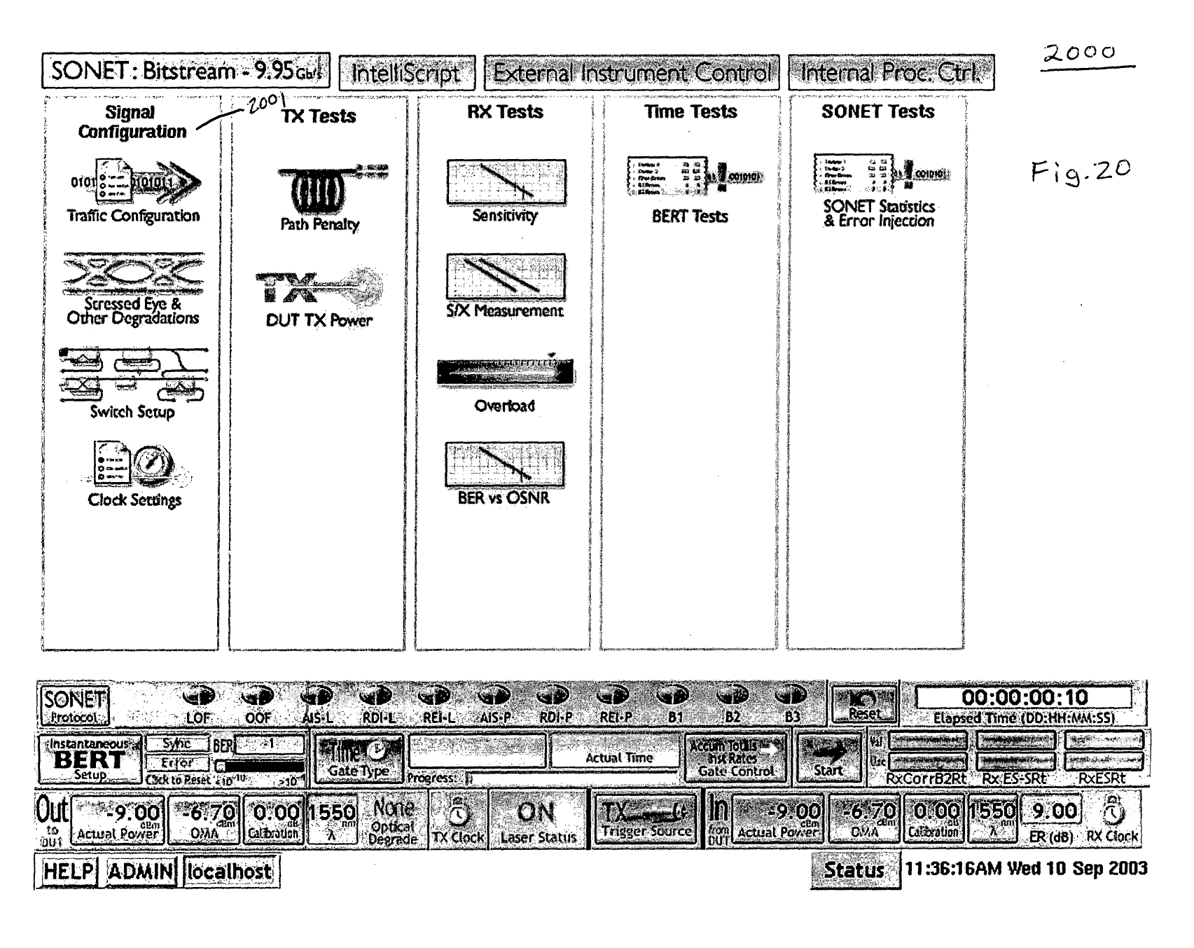

FIG. 20 shows a main display (screen) 2000 of a GUI in accordance with an exemplary embodiment. The main screen 2000 shares many features with the GUI screens described above, such as display 100 of FIG. 1. Common features are not repeated in the interest of clarity. By selecting any of the icons of column 2001 causes the user to enter the Signal Configuration Editor, where each tab corresponds to one of four icons on the front. It is noted that once the user enters the Signal Configuration Editor, the user is then able to go directly to other adjustments.

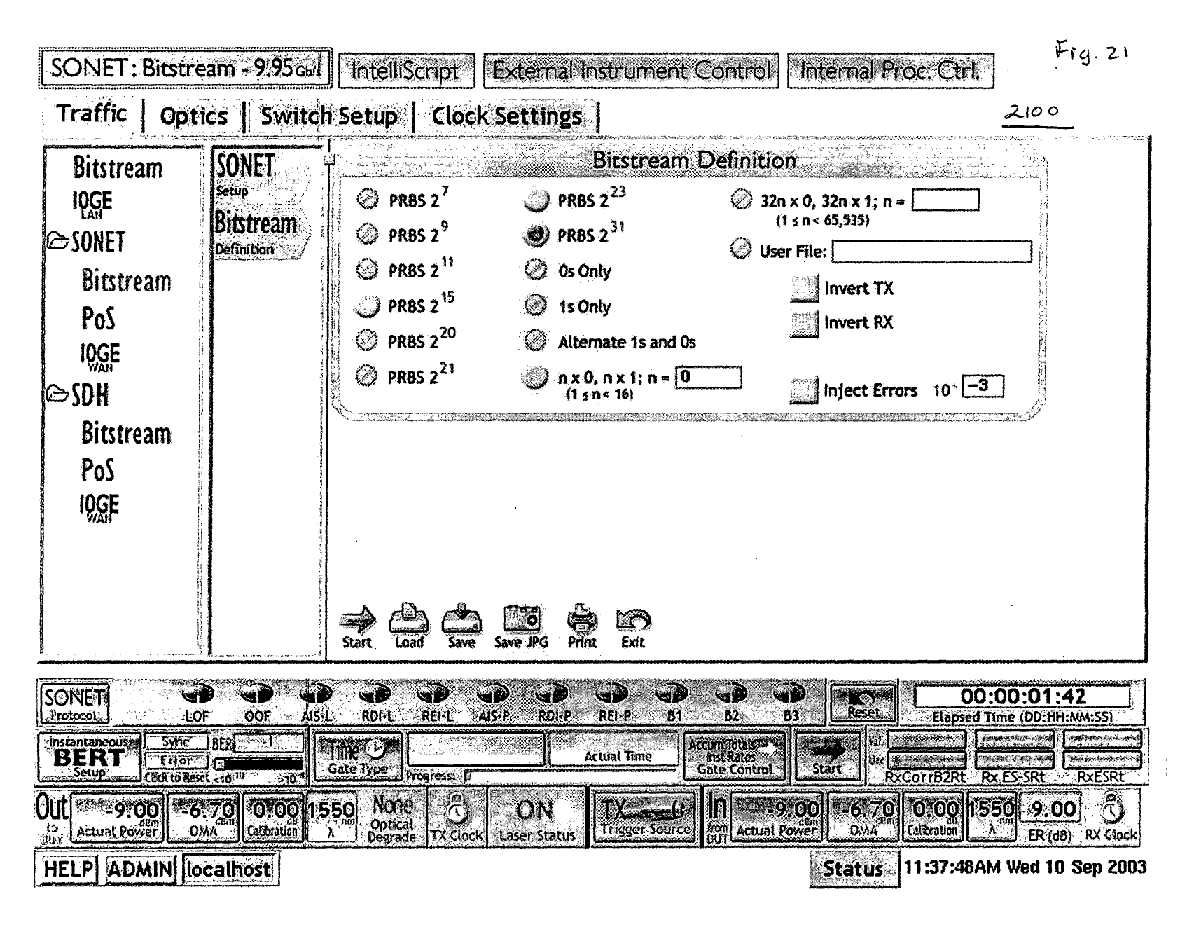

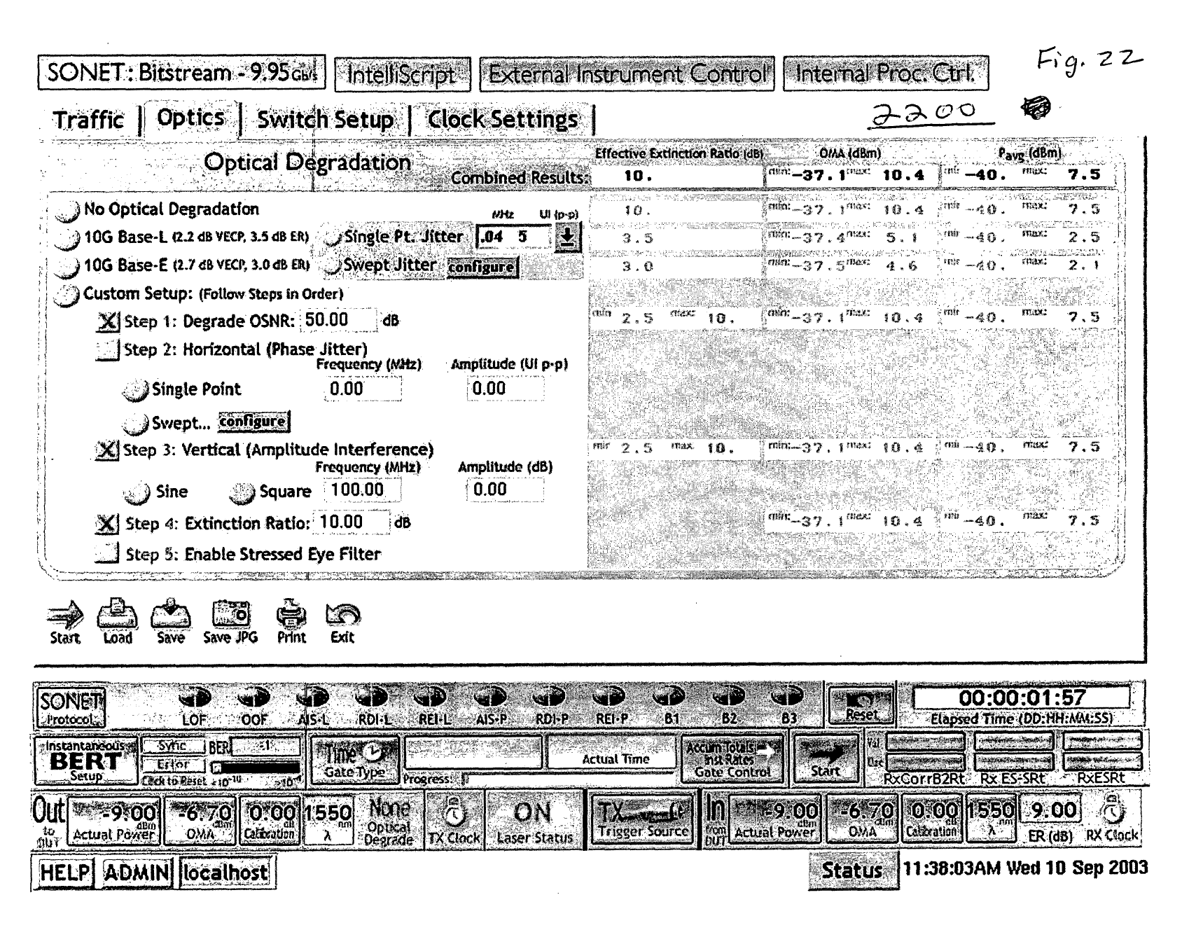

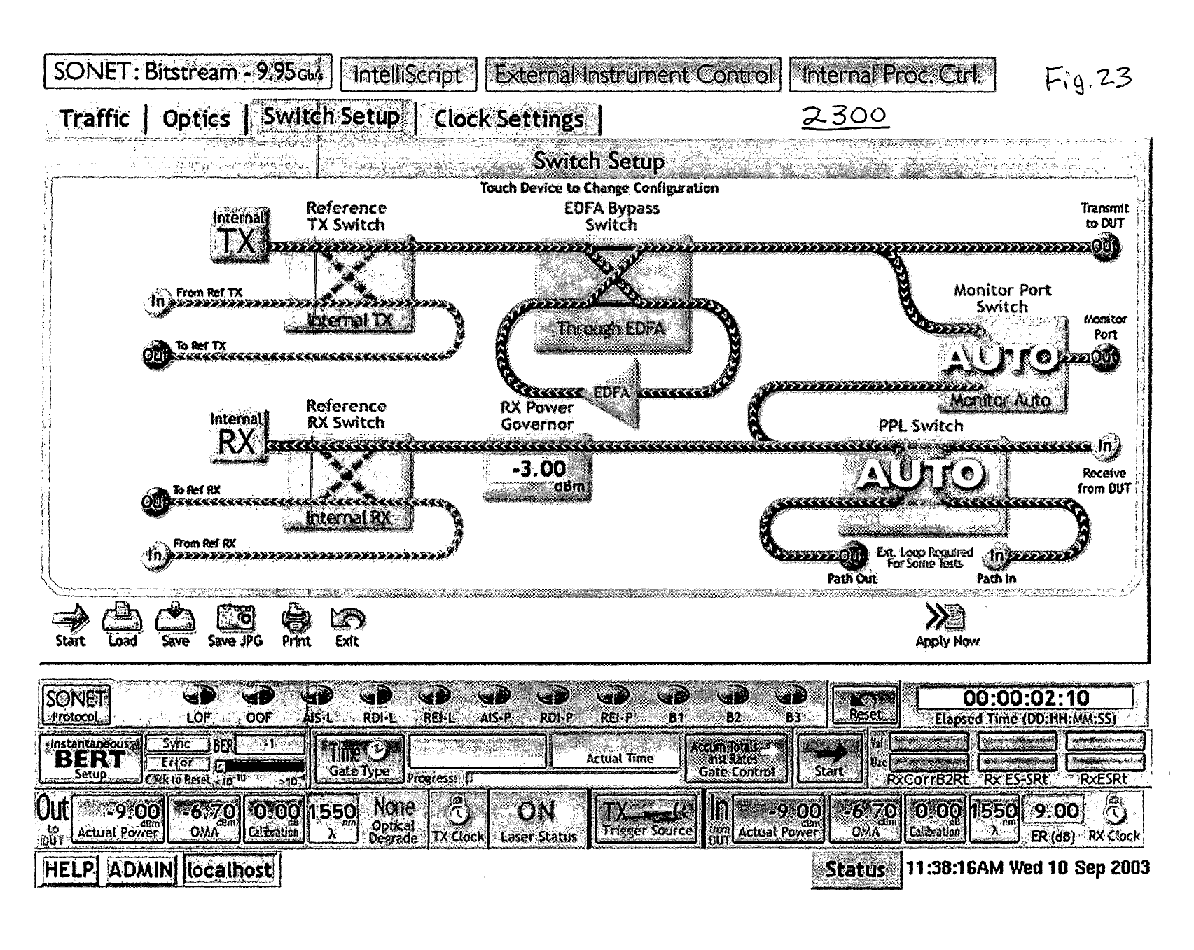

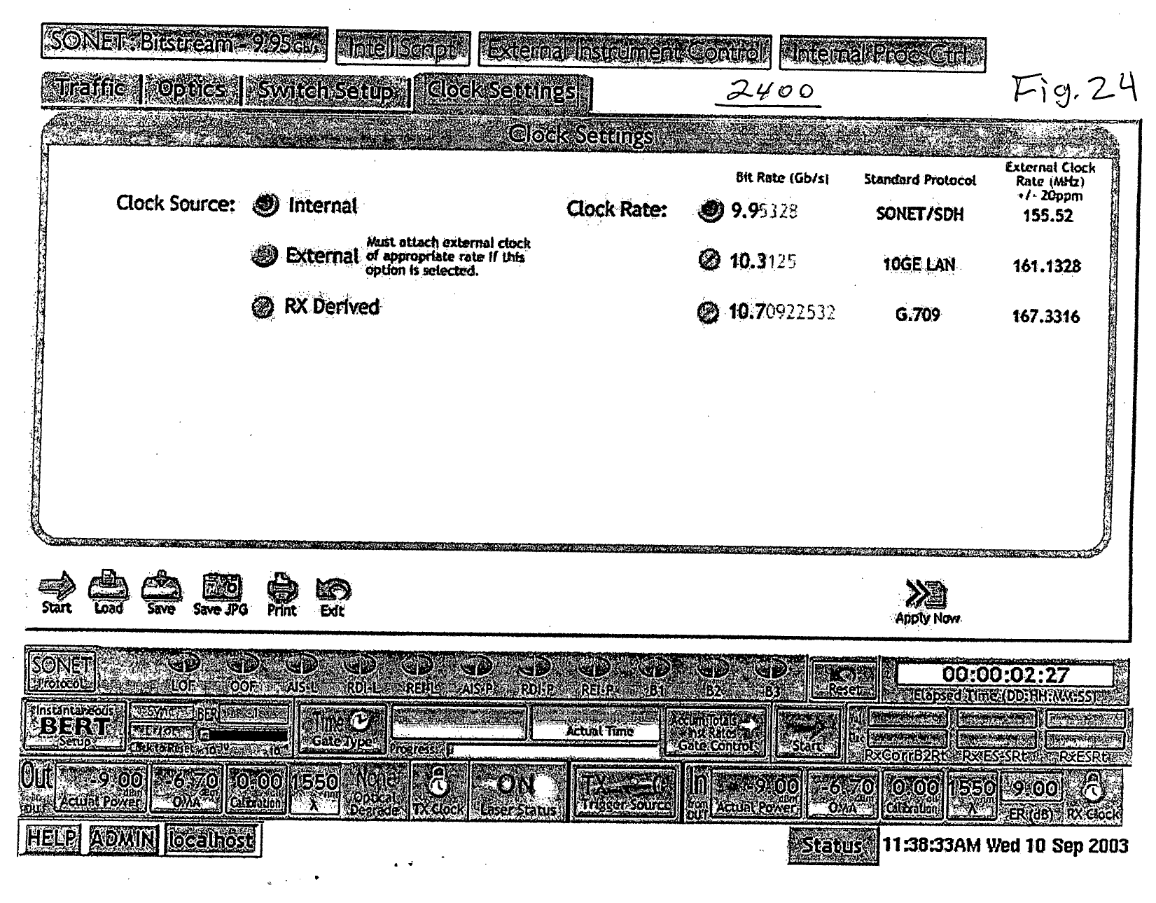

FIG. 21 shows the Traffics Setup Screen 2100 of an exemplary embodiment selectable from the main screen 2000, and FIG. 22 shows an Optical Degradation Screen 2200 of an exemplary embodiment selectable from the main screen 2000. FIG. 23 shows a Switch Configuration Screen 2300 of an exemplary. embodiment, which is also selectable from the main screen 2000. Finally, FIG. 24 shows a Clock Settings Screen 2400 of an exemplary embodiment selectable from the main screen 2000. Of course, each of the screens of FIGS. 21-24 are GUI's as well.

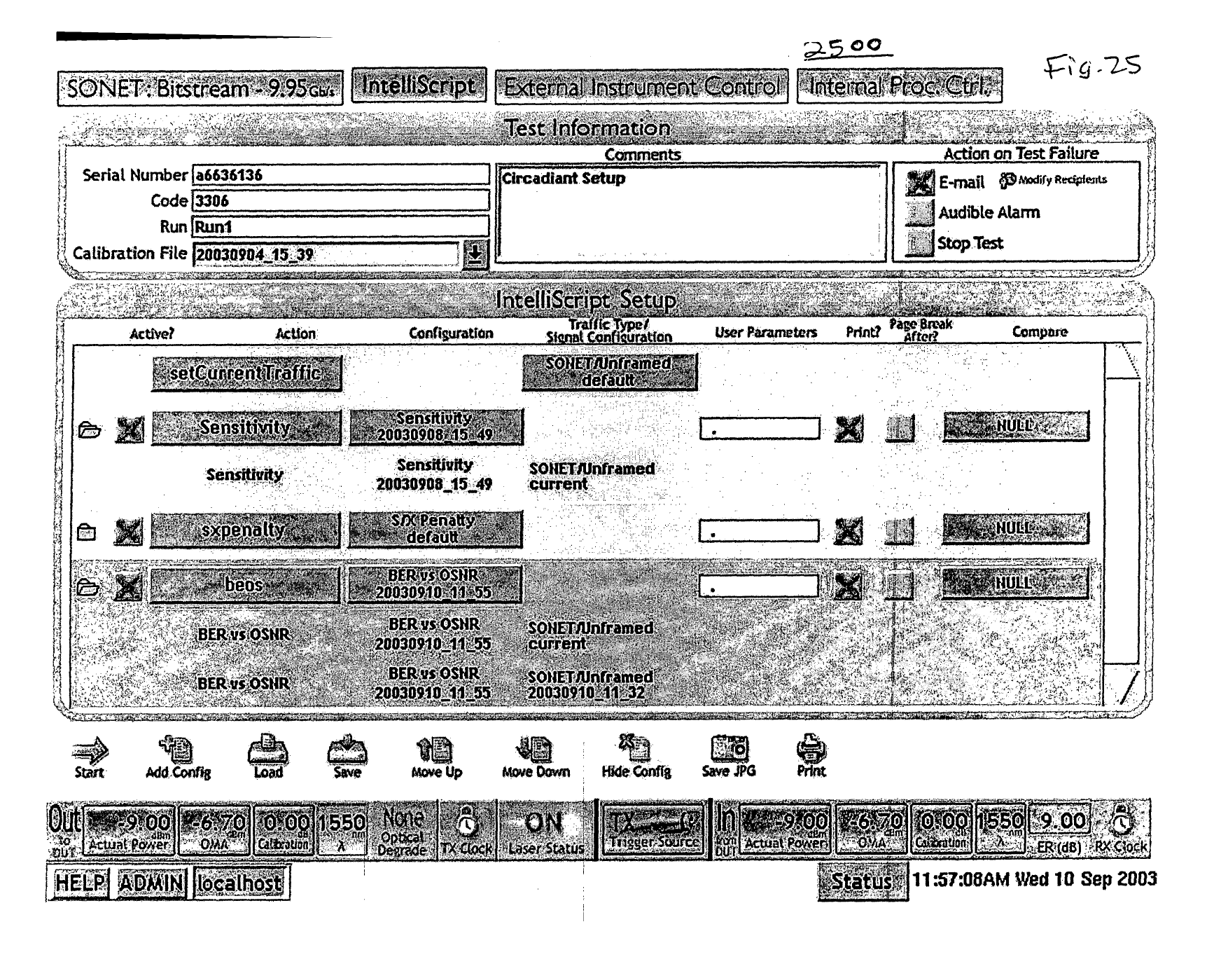

FIG. 25 shows a main IntelliScript GUI Screen 2500 in accordance with an example embodiment. This screen has many common features to the IntelliScript GUI discussed above.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. A graphical user interface (GUI) for interfacing between a user and a controller of test equipment used to test a device under test (DUT), the GUI comprising:
a traffic icon operable to facilitate the user's setting of traffic parameters relating to a test of a DUT; and
an optics icon operable to facilitate the user's setting of optics parameters relating to the test.

2. A GUI as in claim 1, further comprising a local host icon being operable to present a list of test equipment connected to the GUI to the user for selection of at least one test equipment to conduct the test.

3. A GUI as in claim 1, further comprising:
a TX out icon operable to control a transmit power level of a transmitted test signal;
a calibration icon operable to control calibration; and
a wavelength icon operable to control a wavelength of the transmitted test signal.

4. A GUI as in claim 1, further comprising:
an RX in icon operable to display received power;
a calibration icon operable to display calibration information;
a wavelength icon operable to display a received test signal wavelength; and
a maximum receive power icon operable to control a maximum power input from the received signal.

5. A GUI as in claim 1, further comprising:
a bitstream icon operable to facilitate the user's setting of non-SONET-framed bitstream parameters relating to the test; and
a SONET icon operable to facilitate the user's setting of SONET parameters relating to the test,
wherein the bitstream icon and the SONET icon are displayed to the user when the traffic icon has been selected.

6. A GUI as in claim 5, further comprising:
a 10GE Ian icon operable to facilitate the user's setting of 10GE parameters relating to the test;
an SDH icon operable to facilitate the user's setting of SDH parameters relating to the test; and
an OTN icon operable to facilitate the user's setting of OTN parameters relating to the test,
wherein the 10GE Ian icon, the SDH icon and the OTN icon are displayed to the user when the traffic icon has been selected.

7. A GUI as in claim 5, further comprising:
a POS icon operable to facilitate the user's setting of POS parameters relating to the test; and
a 10GE wan icon operable to facilitate the user's setting of 10GE wan parameters relating to the test,
wherein the POS icon and the 10GE wan icon are displayed to the user when the SONET icon has been selected.

8. A GUI as in claim 5, further comprising a SONET bitstream icon operable to facilitate the user's setting of SONET bitstream parameters relating to the test, the SONET bitstream icon being displayed to the user when the SONET icon has been selected.

9. A GUI as in claim 8, further comprising:
a SONET set up icon operable to facilitate the user's setting of SONET setup parameters relating to the test; and
a SONET bitstream definition icon operable to facilitate the user's setting of bitstream definition parameters relating to the test,
wherein the SONET set up icon and the SONET bitstream definition icon are displayed to the user when the SONET bitstream icon has been selected.

10. A GUI as in claim 9, wherein the SONET bitstream definition parameters comprise:
a plurality of PRBSs;
0's only;
1's only;
alternating 1's and 0's;
at least one ratio of 1's to 0's;
user files;
inversion of a transmitted signal;
inversion of a received signal; and
injection of errors at a user selectable rate.

11. A GUI as in claim 9, further comprising:
a first byte value icon operable to facilitate the user's setting of a byte value for at least one SONET overhead byte;
a second byte value icon operable to facilitate the user's setting of a byte value for at least one SONET path byte;
an enable overhead sequencing icon operable to facilitate the user's setting of overhead sequencing options; and
an unscramble payload icon operable to control unscrambling of a payload of a testing signal,
wherein the first byte value icon, the second byte value icon, the enable overhead sequencing icon and the unscramble payload icon are displayed to the user when the SONET set up icon has been selected.

12. A GUI as in claim 11, wherein the overhead sequencing parameters comprise a user selectable number of repetitions for at least one frame.

13. A GUI as in claim 11, further comprising:
a binary icon;
a hexadecimal icon; and
a decimal icon,
wherein the binary icon, the hexadecimal icon and the decimal icon are displayed to the user when the first and/or second byte value icons have been selected.

14. A GUI as in claim 13, further comprising a hexadecimal keypad icon operable to facilitate the user's entering a hexadecimal value, the hexadecimal keypad icon comprising 16 numeric keys and being displayed to the user when the hexadecimal icon has been selected.

15. A GUI as in claim 13, further comprising a binary keypad icon operable to facilitate the user's entering a binary value, the binary keypad icon comprising 2 numeric keys and being displayed to the user when the binary icon has been selected.

16. A GUI as in claim 5, further comprising:
a bitstream definition icon operable to facilitate the user's setting of non-SONET-framed bitstream definition parameters relating to the test; and
a bitrate icon operable to facilitate the user's setting of non-SONET-framed bitrate parameters relating to the test,
wherein the bitstream definition icon and the bitrate icon are displayed to the user when the non-SONET-framed bitstream icon has been selected.

17. A GUI as in claim 16, wherein the non-SONET-framed bitrate definition parameters comprise:
a plurality of PRBSs;
0's only;
1's only;
alternating 1's and 0's;
at least one ratio of 1's to 0's;
user files;
inversion of a transmitted signal;
inversion of a received signal; and
injection of errors at a user selectable rate.

18. A GUI as in claim 16, wherein the non-SONET-framed bitrate parameters comprise at least one bitrate.

19. A GUI as in claim 1, wherein the optics parameters comprise:
no optical degradation;
phase jittering;
amplitude interference; and
signal filtering.

20. A GUI as in claim 19, wherein the optics parameters further comprise user customizable parameters comprising:
OSNR level;
eye stress; and
extinction ratio.

21. A GUI as in claim 1, further comprising:
a start icon operable to control the test;
at least one signal configuration icon operable to facilitate the user's setting of signal configuration parameters relating to the test;
at least one transmit test icon operable to facilitate the user's setting of transmit test parameters relating to the test;
at least one receive test icon operable to facilitate the user's setting of receive test parameters relating to the test; and
at least one time test icon operable to facilitate the user's setting of time test parameters relating to the test,
wherein the at least one signal configuration icon, the at least one transmit test icon, the at least one receive test icon and the at least one time test icon are displayed to the user when the start icon has been selected.

22. A GUI as in claim 21, wherein the at least one signal configuration icon comprises:
a traffic configuration icon operable to facilitate the user's setting of traffic configuration parameters;
an OSNR configuration icon operable to facilitate the user's setting of OSNR configuration parameters;
an extinction ratio icon operable to facilitate the user's setting of extinction ratio parameters;
a frequency offset icon operable to facilitate the user's setting of frequency offset parameters; and
an interfering laser icon operable to facilitate the user's setting of interfering laser parameters.

23. A GUI as in claim 21, wherein the at least one transmit test icon comprises:
a path penalty icon operable to facilitate the user's setting of path penalty parameters; and
a DUT transmit power icon operable to facilitate the user's setting of DUT transmit power parameters.

24. A GUI as in claim 21, wherein the at least one receive test icon comprises:
a sensitivity icon operable to facilitate the user's setting of sensitivity test parameters; and
an S/X measurement icon operable to facilitate the user's setting of S/X measurement parameters.

25. A GUI as in claim 24, wherein the at least one receive test icon further comprises:
an overload icon operable to facilitate the user's setting of overload parameters;
a flag switching icon operable to facilitate the user's setting of flag switching parameters; and
a BER versus OSNR icon operable to facilitate the user's setting of BER versus OSNR parameters.

26. A GUI as in claim 24, further comprising a sensitivity test start icon operable to control the test, the sensitivity test start icon being displayed to the user when the sensitivity test icon has been selected, and wherein the sensitivity test parameters comprise:
power;
BER; and
pass criteria.

27. A GUI as in claim 26, further comprising a sensitivity test results display being displayed to the user when the sensitivity test start icon has been selected, the sensitivity test results display comprising:
an indication of whether the DUT passed or failed the sensitivity test or whether pass or fail is unknown; and
a graph of BER versus power.

28. A GUI as in claim 26, further comprising an add configuration icon operable to facilitate the user's selection of additional tests to be performed on the DUT.

29. A GUI as in claim 24, further comprising an S/X measurements result display being displayed to the user when the S/X measurements icon has been selected, the S/X measurements result display comprising:
an indication of whether the DUT passed or failed the SIX measurement or whether pass or fail is unknown; and
a graph of BER versus power.

30. A GUI as in claim 29, wherein the graph comprises two plots.

31. A GUI as in claim 21, wherein the at least one time test icon comprises:
a strip chart icon operable to facilitate the user's setting of strip chart parameters;
an error distribution analysis icon operable to facilitate the user's setting of error distribution parameters; and
an event timing icon operable to facilitate the user's setting of event timing parameters.

33. A GUI as in claim 1, further comprising:
a BERT set up icon operable to facilitate the user's setting of bit error rate test parameters; and
a BERT start icon operable to control starting the test.

34. A graphical user interface (GUI) for interfacing between a user and a controller of test equipment used to test a device under test (DUT), the GUI comprising:
a test icon operable to facilitate the user's setting of test parameters relating to a test to be performed on the DUT;
an IntelliScript icon operable to facilitate the user's selection of a plurality of tests to perform on the DUT;
a manual icon operable to facilitate the user's manual overriding of software-driven parameters relating to the test;
a calibration icon operable to facilitate a calibration of the test equipment; and
a monitor icon operable to facilitate the user's monitoring of the test.

35. A GUI as in claim 34, further comprising:
a sensitivity icon operable to facilitate the user's setting of sensitivity parameters;
an overload icon operable to facilitate the user's setting of overload parameters;
an S/X penalty icon operable to facilitate the user's setting of S/X penalty parameters; and
a start icon operable to control the plurality of tests and display results of the plurality of tests;
wherein the sensitivity icon, the overload icon, the S/X penalty icon and the start icon are displayed when the IntelliScript icon has been selected.

36. A graphical user interface (GUI) for controlling test equipment comprising:
a first field operable to set at least one traffic protocol parameter; and
a second field operable to set at least one signal quality parameter.

37. A GUI as in claim 36, wherein the at least one traffic protocol parameter comprises at least one of:
non-SONET-framed bitstream;
10GE Ian;
SONET framed bitstream;
SONET framed POS;
SONET framed 10GE wan; and
OTN.

38. A GUI as in claim 37, wherein the at least one traffic protocol comprises at least one of:
PRBS;
0's only;
1's only;
alternating 1's and 0's;
at least one ratio of 1's to 0's;
user file;
bitrate selection; and
byte selection.

39. A GUI as in claim 36, wherein the at least one signal quality parameter comprises at least one of:
signal power;
phase jitter;
amplitude interface;
degrade OSNR;
extinction ratio; and
eye stress.

40. A method for controlling test equipment comprising:
providing a graphical user interface (GUI), the GUI comprising a first field operable to facilitate a user to set at least one traffic protocol parameter and a second field operable to facilitate the user set at least one signal quality parameter; and
operating upon user settings to affect the test equipment.

41. A method for controlling test equipment as in claim 40, wherein the at least one traffic protocol parameter comprises at least one of:
non-SONET-framed bitstream;
10GE Ian;
SONET framed bitstream;
SONET framed POS;
SONET framed 10GE wan; and
OTN.

42. A method for controlling test equipment as in claim 41, wherein the at least one traffic protocol comprises at least one of:
PRBS;
0's only;
1's only;
alternating 1's and 0's;
at least one ratio of 1's to 0's;
user file;
bitrate selection; and
byte selection.

43. A method for controlling test equipment as in claim 40, wherein the at least one signal quality parameter comprises at least one of:
signal power;
phase jitter;
amplitude interface;
degrade OSNR;
extinction ratio; and
eye stress.
